(19) United States
(12) Patent Application Publication
(10) Pub. No.: US 2017/0307289 A1
(43) Pub. Date: Oct. 26, 2017

(54) DEVICE THAT CAN BE USED TO HEAT AND/OR REFRIGERATE AND/OR MAINTAIN THE TEMPERATURE OF A RECEPTACLE SUITED TO HOUSING FOODSTUFFS IN PARTICULAR

(71) Applicant: COLDWAY, Pia (FR)

(72) Inventors: Laurent RIGAUD, Pia (FR); Francis KINDBEITER, Pia (FR); David TADIOTTO, Pia (FR)

(73) Assignee: COLDWAY, Pia (FR)

(21) Appl. No.: 15/516,120

(22) PCT Filed: Sep. 29, 2015
(86) PCT No.: PCT/FR2015/052601

§ 371 Date: Mar. 31, 2017

(30) Foreign Application Priority Data
Oct. 1, 2014 (FR) 1459334

(51) Int. Cl. F25D 31/00; F25D 11/02; A47J 39/00; F25D 25/02; A47J 36/28

(52) U.S. Cl. CPC F25D 31/005; F25D 25/028; A47J 36/28; A47J 39/006; F25D 11/02

(57) ABSTRACT

The present invention relates to a device that can be used for heating and/or refrigerating and/or maintaining the temperature of a receptacle. According to the invention, characteristically it comprises a base module which comprises: heat-producing means (5) and cold-producing means (7), said cold producing means comprising a reservoir (7) containing a fluid and possibly connected to an evaporator, said heat-producing means comprise a thermochemical reactor (5) connected to said reservoir (7) and containing a reagent able to react reversibly with said fluid during an exothermal reaction:—means forming a valve that allows said reservoir (7) or said evaporator to be connected to said thermochemical reactor (5) to produce heat in said reactor (5) as a result of said aforementioned exothermal reaction and simultaneously to produce cold in said reservoir (7), as the result of the expansion and/or evaporation of said fluid;—at least one receptacle (3) made of a thermally conducting material which has a first face able to house the foodstuff that is to be heated/refrigerated and a second face, opposite to said first face and arranged in contact with said heat-producing means (5) or said cold-producing, means (7);—an insulating element (15) which thermally insulates said heat-producing means (5) from said cold-producing means (7); and said reactor (5) and/or said receptacle (3) are removably mounted on said base module.

The present invention concerns a device for heating and/or cooling and/or maintaining at temperature a receptacle suitable for receiving food products in particular.

In the food industry or food service, it is important to be able to maintain food or ready-cooked dishes at temperature. Sometimes it must also be reheated at a location far from the place where it was prepared.

The document WO 2013/098516 A describes a self-contained trolley for temperature conditioning of meal trays. The trolley is divided vertically into two zones, one cold the other hot. The meal trays with food are slid into the trolley horizontally; one half of the tray is cooled, the other heated. The heat production means and the cold production means used comprise a thermochemical reactor, connected to a reservoir of fluid by valve means. By opening the valve means, the gas in the reservoir is expanded or the liquid contained therein is vaporized. The expansion of the gas or the vaporization thereof causes the production of cold in the reservoir. The gas exiting the reservoir reacts with the reagent contained in the reactor, in a reversible exothermic chemical reaction, thus releasing calories in the thermochemical reactor. By heating the reactor, the reverse reaction is produced: the reagent is regenerated and the gas produced again fills the reservoir, under the effect of the pressure.

The device described in the aforementioned document has several disadvantages. The space in the cold zone and the space in the hot zone cannot be adjusted based on the number of trays to be conditioned. The thermochemical system comprising the reactor and the reservoir is integral with the trolley and cannot be removed; during regeneration of the reagent, the trolley is therefore unusable. Moreover, the trolley is cumbersome and does not allow easy access to the trays; it cannot be used in a buffet, for example, because the foods are only visible if the trolley is opened and a tray is pulled out. Although the trays can be removed, cleaning the interior of the trolley is difficult particularly because of the presence of electrical resistances used for regeneration of the reactors.

A purpose of the present invention is to propose a device that makes it possible to resolve at least one of the aforementioned disadvantages.

The present invention proposes a self-contained and transportable device for heating and/or cooling and/or maintaining at temperature a receptacle suitable for receiving food products in particular.

Thus, the present invention concerns a device for heating and/or cooling and/or maintaining at temperature a receptacle suitable for receiving food products in particular.

Characteristically, according to the invention the device comprises a base module which comprises:
heat production means and cold production means, said cold production means comprising a reservoir containing a fluid and possibly connected to an evaporator, said heat production meetings comprising a thermochemical reactor connected to said reservoir and containing a reagent capable of reacting reversibly with said fluid during an exothermic reaction;
valve means enabling said reservoir or said evaporator to be connected to said thermochemical reactor for the production of heat at said reactor, due to the aforementioned exothermic reaction and for the simultaneous production of cold at said reservoir, resulting from the expansion and/or evaporation of said fluid;
at least one receptacle of thermally conductive material that has a first face capable of receiving the food to be heated/cooled and a second face, opposite to said first face and disposed in contact with said heat production means or said cold production means;
an insulating element which thermally insulates said production means (5) from said cold production means;
   and said reactor and/or said receptacle are mounted so as to be removable from said base module.

The aforementioned module makes it possible to produce heat and cold at the same time, and said heat and cold can be used simultaneously or not. The module enables food products placed in the receptacle to be heated or cooled. Said receptacle can be a plate or a deep dish, for example.

The aforementioned means of cold and heat production constitute a thermochemical system. Said system makes the module of the invention self-contained, i.e. it can function at least over a given period of time without supply of outside energy. The reagent can advantageously be manganese chloride or a solid block obtained by compaction of manganese chloride and expanded natural graphite. The fluid can be ammonia. With such a reagent and gas, a temperature can be obtained substantially equal to or greater than 2° C. and substantially equal to or less than 4° C. at the reservoir and a temperature of more than 63° C. at the reactor. Said temperatures are particularly suitable for the domain of food service. The aforementioned heat and cold production means enable heat and cold to be produced simultaneously and make the device self-contained and therefore transportable.

The fact that the receptacle made of thermally conductive material is in direct contact with the reactor or the reservoir (and/or possibly the evaporator) allows thermal transfer by conduction and not by convection, as is the case in the aforementioned prior art. The cooling/heating is therefore faster and requires less energy.

Moreover, the fact that the receptacle and/or the reactor can be removed from the module facilitates the cleaning of the latter.

Advantageously, the module has a cross-section of the same dimensions as those of standard meal trays (“Gastronorm” GN1/1), namely 325 mm wide and 530 mm long. The basic module can therefore be mounted in any container suitable for receiving meal trays.

According to one embodiment, the device comprises a cabinet, possibly at least partially made of thermally insulating material, which has a substantially horizontal upper face, said upper face having an opening, said base module being capable of being mounted in said cabinet, and when said base module is mounted in said cabinet, said receptacle is disposed either substantially at said opening or above said opening, said first face of said receptacle being oriented in the direction opposite to said cabinet. The aforementioned cabinet makes it possible to use the device of the invention easily and also makes it possible to have a storage volume, for example, which is cooled or heated depending on whether the receptacle itself is heated or cooled. Said volume can be situated, for example, around the base module.

Advantageously, the base module comprises a box made of thermally insulating material which contains the heat production means, the cold production means and the thermally insulating element.

According to one particular embodiment, said cabinet being at least partially made of thermally insulating material and extending beneath the base module, said base module is adapted to cooperate with said cabinet in such a way as to thermally insulate the internal volume of said cabinet situated beneath said base module.

According to another embodiment, the device of the invention comprises a container inside which said base module can be mounted and said base module is capable of cooperating with the interior of said container in order to separate the interior of said container into two thermally insulated zones.

The method of assembly of the base module in the aforementioned cabinet or the aforementioned container is not limited according to the invention. Thus, the base module can comprise at least two bars, said cabinet or said container can comprise support means and said bars and said support means are disposed respectively on said base module and in said cabinet/container in such a way that when said bars are supported on said support means said receptacle is disposed horizontally in said cabinet/said container. When the container comprises a plurality of support means, it is possible to maintain the base module at different levels in the container. The user can therefore vary the volumes of hot zones and cold zones depending on the needs.

Advantageously, said receptacle and/or said heat production means and/or said cold production means and/or said insulating element is (are) mounted removably. This enables the receptacle to be placed either in contact with the heat production means, or in contact with the cold production means. If the insulating element, the reactor, the valve means and the reservoir form an integral unit, said unit can easily be removed from the module, and depending on the element that is placed in contact with the receptacle, heat or cool said module.

According to another embodiment, the heat production means or the cold production means are mounted so as to be removable from the base module. In this case, said device can further comprise an additional receptacle capable of being mounted on said heat production means/cold production means particularly when said means are removed from the base module. Thus, a base module is obtained, for example, that heats a first receptacle while another element formed by the cold production means cools the additional receptacle.

Advantageously, the device comprises means of regenerating said thermochemical reactor. Said means can for example be electrical resistances surrounding the exterior of the reactor.

Advantageously, the regeneration means are external to the base module. For example, according to one embodiment, the device according to the invention comprises means of heating said reactor that are capable of being placed in contact with said reactor, which is mounted so as to be removable from the base module. Thus, the base module has no electrical element and is therefore easily washable with water.

The base module can comprise at least one box containing the thermochemical system, separated into two compartments by said insulating element. The module is therefore easy to transport. The box can be made of thermally insulating material.

According to one variant, the box is formed of two separable boxes, one box comprising said reactor and the other said reservoir. This variant makes it possible to dissociate the heat production means and the cold production means and to use them side by side, for example.

The box can comprise lateral bars which enable their assembly onto a cabinet or in a container, for example. Said bars can also serve as handles for the module.

When the box is formed from two separable boxes, each box can comprise lateral bars.

The present invention, its characteristics and the different advantages will be understood more clearly from the following detailed description of six embodiments of the present invention, with reference to the appended drawings in which:

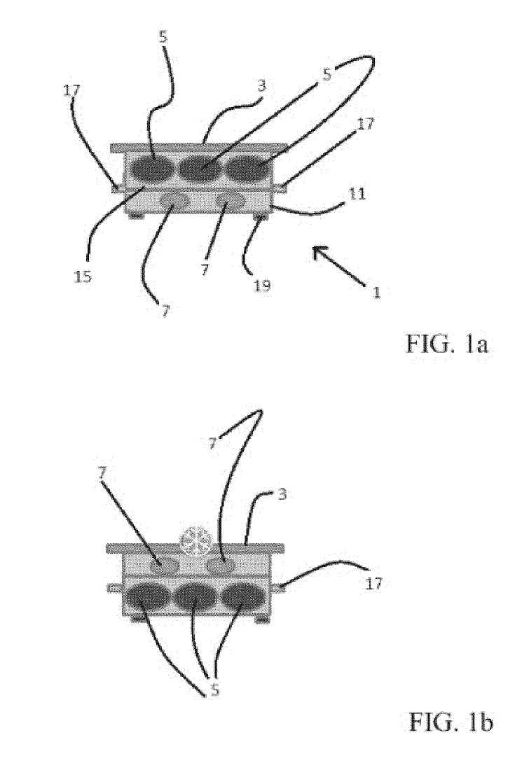

FIGS. 1a and 1b schematically represent a cross-sectional view along a vertical plane of one particular embodiment of the base module, the receptacle being hot in the case of FIG. 1a, and cold in the case of FIG. 1b;

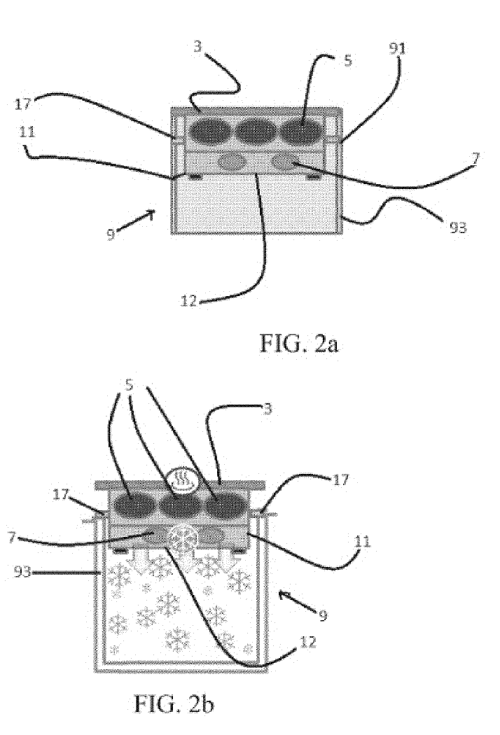

FIG. 2b schematically represents a cross-sectional view along a vertical plane of a variant of the second embodiment of the invention represented in FIG. 2a;

FIG. 3 represents a schematic view in cross-section along a vertical plane of a third embodiment of the invention, the base module being identical to the embodiment represented in FIG. 1;

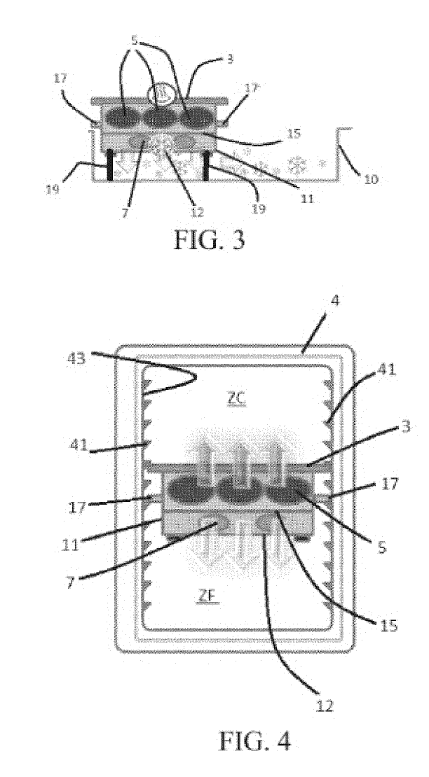

FIG. 4 represents a schematic view in cross-section along a vertical plane of a fourth embodiment of the invention, the base module being identical to the embodiment represented in FIG. 1;

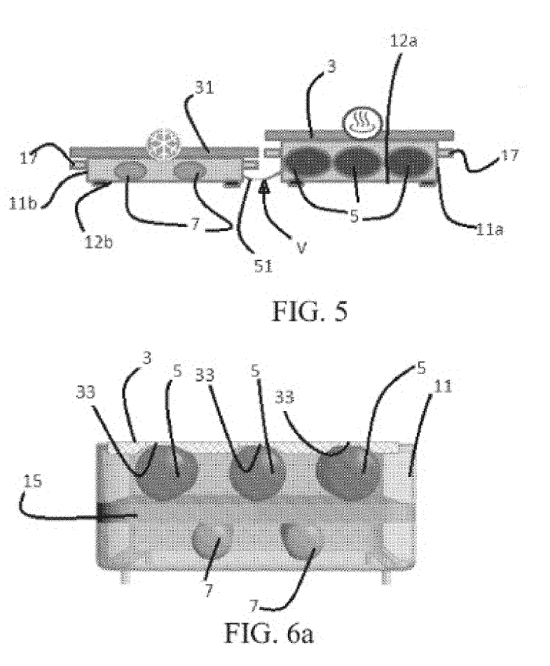

FIG. 5 represents a schematic view in cross-section along a vertical plane of a fifth embodiment of the base module; and

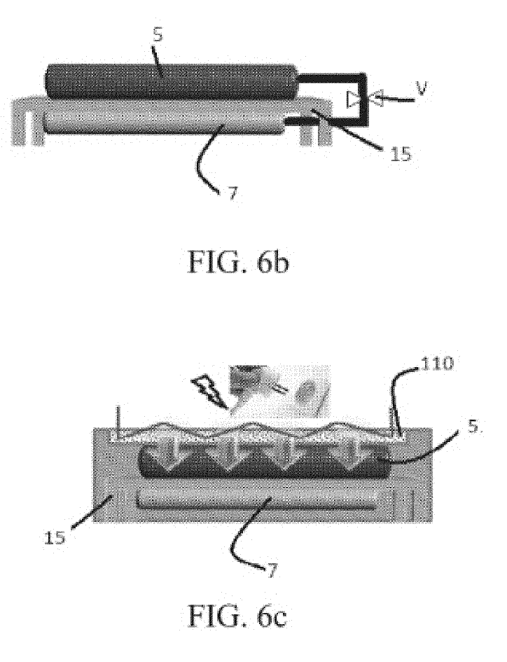

FIG. 6a represents a view in perspective, the box 11 being transparent, of a third embodiment of the base module;

FIG. 6b represents a side view of the insulating element, reactors and reservoirs of the module represented in FIG. 6a; and

FIG. 6c represents a view in transverse cross-section of the aforementioned device during regeneration of the reactors.

With reference to FIGS. 1a and 1b, a particular embodiment of the base module of the device according to the invention will now be described. As represented in FIG. 1a, according to said embodiment, the base module 1 comprises a box 11 separated into two compartments by an insulating element 15 which is horizontal; the insulating element 15 thus defines an upper compartment and a lower compartment.

The box 11 comprises a bar 17 on each side. The bars 17 extend over the full length of the box 11 and extend beyond it at both sides, along its width. The box 11 is provided with feet 19. The box 11 has an open upper face which is closed by a receptacle made of a conductive material. Said receptacle is in the present case a thermally conductive plate 3. Housed in the box 11 are the thermochemical reactors 5 and the reservoirs 7. The connection tubes between the reactors in the reservoirs as well as the valve means are not represented in FIGS. 1a and 1b. In the present case, the base module comprises two reservoirs connected to each other in parallel and connected to three thermochemical reactors 5 which are also connected in parallel. The reservoirs 7 advantageously serve as evaporator, i.e. they are constructed, when the valve means are opened, to allow the evaporation of the liquefied gas they contain, then the expansion of the gas thus produced to the thermochemical reactors 5. The bottom 12 of the box 11 which closes the lower compartment thereof is provided with openings allowing natural convection; the box 11 and the bars 17 are made of insulating material.

FIG. 1a represents a device in which the plate 3 is capable of heating food products (or a tray containing food products) disposed thereon. To do this, the thermochemical reactors 7 are disposed beneath the plate 3 and preferably in contact therewith. The reservoirs 7 are situated in the lower compartment of the box 11, on the other side of the insulating element 15.

In the particular embodiment of the base module represented in FIGS. 1a and 1b, the thermochemical reactors 5 and the reservoirs 7 are removable and can be mounted in either of the compartments formed in the box 11 by the insulating element 15. Thus, by removing the reactors 5 and the reservoirs 7 and by inverting their position, it is possible to change from the configuration represented in FIG. 1a to the one represented in FIG. 1b.

In FIG. 1b, which represents the same embodiment of the base module, the reservoirs 7 are mounted in the upper compartment and are in direct contact with the plate 3. Said plate is therefore cold and enables a food product or tray placed on the free upper surface thereof to be cooled.

An example of utilization of the base module of the device according to the invention will now be described with reference to FIGS. 1a and 1b. Depending on the needs, the user chooses to mount the reactors in the upper compartment or in the lower compartment of the box 11. Once the reactors 5 and reservoirs 7 have been mounted, the user opens the valve means. The liquefied gas contained in the reservoirs 7 is vaporized, creating cold in the reservoirs 7, then enters simultaneously into the three thermochemical reactors 5 where it reacts with the reagent contained in the reactor 5, thus producing heat. If the reactors 5 are situated in the lower compartment, the heat is evacuated below the base module by natural convection, or forced convection if a fan is used for example, installed in the bottom of the box 11. The same is true if the reservoirs 7 are mounted in the lower compartment of the box 11. The base module 1 can produce the heat and the cold while the reservoirs 7 contain the gas. When all of the gases been consumed in the reaction with the reagent, the reactors 7 must be heated to trigger the reverse reaction. Said heating will be more fully described with reference to FIG. 6.

FIG. 2a represents a second embodiment of the present invention. The elements in common with the first embodiment represented in FIGS. 1a and 1b have identical references. In this embodiment, in addition to the base module 1 the device comprises a cabinet 9. The upper face of the cabinet 9 is open and the base module 1 can be inserted into the opening defined by said face. The bars 17 rest on the supports 91 provided on the inner face of the vertical walls 93 of the cabinet 9. This embodiment makes it possible to easily use the base module for a buffet, for example, the plate being at the height of the guests, the dish it holds being easily accessible and maintained at temperature.

In the variant represented in FIG. 2b, the bars 17 rest on the thickness of the vertical walls 93 of the cabinet 9. Said cabinet is made of a thermally insulating material; its internal volume is therefore cooled by the reservoirs 7 and can serve as storage of beverages, for example.

With reference to FIG. 3, a third embodiment will be described. The elements in common with the other embodiments have identical references. In said third embodiment, the base module 1 is disposed in a cabinet forming a trough 10 that is wider than the base module 1. The cold produced at the reservoirs 7 is evacuated to the side of the module and enables food products located beside the base module 1 to be cooled. The feet 19 in this case are rather high to allow efficient natural convection.

With reference to FIG. 4, a fourth embodiment will now be described. In this embodiment, the device comprises a container 4 which is thermally insulating and closed by a door which is also thermally insulating. The container 4 is equipped with support means 41 that form horizontal grooves disposed facing each other on the internal walls 43 of the container 4. The bars 17 of the base module 1 rest on the lower horizontal walls of the grooves 41 to hold the base module 1 suspended horizontally in the container 4. Said container is therefore separated into two zones by the base module 1, the box 11 of which is thermally insulating, a cold zone ZF and a hot zone ZC. The cold zone is the zone that contains the reservoirs 7 and the hot zone is the zone that contains the thermochemical reactors 5. The utilization of this embodiment is the same as the one described with reference to FIGS. 1a and 1b. The user can thus choose the volume of each of the zones depending on the needs simply by changing the height of the position of the base module 1 in the container 4.

With reference to FIG. 5, a fifth embodiment will now be described. The elements in common with the other aforementioned embodiments have identical references. In this embodiment, the box 11 is formed from two boxes 11a and 11b, the bottom 12a and 12b of which is made of a thermally insulating material. A flexible hose 51 connects the reactors 7 to the reservoir 5. Valve means V are mounted on the flexible hose 51. By superimposing the two boxes 11a and 11b, possibly inverted, the base module is obtained as represented in FIG. 1a or FIG. 1b, the bottoms 12a and 12b forming the insulating element. By separating the two boxes 11a and 11b the configuration represented in FIG. 5 is obtained. The box 11b, which includes the reservoirs 7, is equipped with an additional thermally conductive plate 31 which can be removed from the reactors 7 with which it is in direct contact, in order to allow its washing or the natural convection when the module is used in the configuration represented in FIGS. 1a and 1b, the additional plate then being removed.

FIGS. 6a to 6c represent a sixth embodiment of the invention for which the elements in common with the aforementioned embodiments have identical references. According to this embodiment, as represented in FIGS. 6a and 6b, the assembly formed by the insulating element 15, the reactors 5 in the reservoirs 7 can be removed from the box 11. By turning the aforementioned assembly over, the heating or cooling of the plate 3 can be achieved. It is therefore also possible to easily regenerate the reactors 5 thanks to the heating means 110 represented in FIG. 6c. As represented in FIG. 6a, the plate 3 includes notches 33 which enabled good contact with the outer surface of the reservoirs 7 or reactors 5, thus promoting thermal conduction between said two elements. With reference to FIG. 6b, the assembly formed by the insulating element 15, the reactors 5 and the reservoirs 7, is taken out of the box 11. The reactors 5 are placed in contact with heating means 110 (see FIG. 6c). By thermal transfer, said heating means 110 enable the reactors 5 to reach the temperature of decomposition of the product formed during the reaction between the gas and the reagent. The product of the reaction is decomposed and produces gas. Said gas is dispersed into the reservoirs 7 that it fills again. This method of regeneration makes it possible to do without eating electrical collars disposed around the reactors 5. The box 11 therefore contains no element that needs to be plugged into an electrical outlet. It is therefore particularly safe and completely water washable.

1. A device for heating and/or cooling and/or maintaining at temperature a receptacle suitable for receiving food products in particular, comprising a base module which comprises:
heat production means (5) and cold production means (7), said cold production means comprising a reservoir (7) containing a fluid and possibly connected to an evaporator, said heat production meetings comprising a thermochemical reactor (5) connected to said reservoir (7) and containing a reagent capable of reacting reversibly with said fluid during an exothermic reaction;
valve means enabling said reservoir (7) or said evaporator to be connected to said thermochemical reactor (5) for the production of heat at said reactor (5), due to the aforementioned exothermic reaction and for the simultaneous production of cold at said reservoir (7), resulting from the expansion and/or evaporation of said fluid;
at least one receptacle (3) of thermally conductive material that has a first face capable of receiving the food to be heated/cooled and a second face, opposite to said first face and disposed in contact with said heat production means (5) or said cold production means (7);
an insulating element (15) which thermally insulates said production means (5) from said cold production means (7); and
wherein said reactor (5) and/or said receptacle (3) are mounted so as to be removable from said base module.

2. The device according to claim 1, comprising a cabinet (9; 10), possibly at least partially made of thermally insulating material, which has a substantially horizontal upper face, said upper face has an opening, said base module is capable of being mounted in said cabinet (9; 10), and when said base module is mounted in said cabinet (9; 10), said receptacle (3) is disposed either substantially at said opening or above said opening, said first face of said receptacle (3) being oriented in the direction opposite to said cabinet (9; 10).

3. The device according to claim 2, wherein said cabinet (9) being at least partially made of thermally insulating material and extending beneath the base module, said base module is adapted to cooperate with said cabinet (9) in such a way as to thermally insulate the internal volume of said cabinet (9) situated beneath said base module.

4. The device according to claim 1, comprising a container (4) inside which said base module can be mounted and said base module is capable of cooperating with the interior of said container (4) in order to separate the interior of said container (4) into two thermally insulated zones.

5. The device according to claim 2, wherein said base module comprises at least two bars (17), said cabinet (9; 10) or said container (4) comprises support means (91; 41) and said bars (17) and said support means (91; 41) are disposed respectively on said base module and in said cabinet/container (9; 10; 4) in such a way that when said bars (17) are supported on said support means (91; 41) said receptacle (3) is disposed horizontally in said cabinet/said container (9; 10; 4).

6. The device according to claim 1, wherein said receptacle (3) and/or said heat production means (5) and/or said cold production means (7) and/or said insulating element (15) is (are) mounted so as to be removable from said base module.

7. The device according to claim 6, comprising an additional receptacle (31) capable of being mounted on said heat production means (5)/cold production means (7).

8. The device according to claim 1, comprising means (110) of regenerating said thermochemical reactor (5).

9. The device according to claim 8, wherein said reactor (5) is mounted so as to be removable from said module and said regeneration means comprise heating means (110) that are external of said module and capable of being placed in contact with said reactor (5).

10. The device according to claim 1, wherein said insulating element (15), said reactor (5), said valve means and said reservoir (7) and the possible evaporator form an integral unit that can easily be removed from the module.

11. The device according to claim 1, wherein said reactor (5) is mounted so as to be removable from said module.

12. The device according to claim 1, wherein said receptacle (3) is mounted so as to be removable from said module.

13. The device according to claim 1, wherein said base module comprises at least one box (11) separated into two compartments by said insulating element (15).

14. The device according to claim 13, wherein said box (11) is formed from two separable boxes, one box comprising said reactor (5) and the other said reservoir (7).

15. The device according to claim 13, wherein said box (11) comprises lateral bars (17).

16. The device according to claim 14, wherein each box comprises lateral bars (17).
